(19) United States
(12) Patent Application Publication
(10) Pub. No.: US 2026/0131748 A1
(43) Pub. Date: May 14, 2026

(54) REAR INFOTAINMENT SYSTEM FOR RECREATIONAL VEHICLE

(71) Applicant: Textron Inc., Providence, RI (US)

(72) Inventors: Ricky Veldee Kemp, Augusta, GA (US); Donny Lee Hammond, Augusta, GA (US); Trevor Douglas Roebuck, Evans, GA (US); Baily Guyton Wood, Dublin, GA (US)

(73) Assignee: Textron Inc., Providence, RI (US)

(21) Appl. No.: 18/947,807

(22) Filed: Nov. 14, 2024

(51) Int. Cl. B60R 16/04; B60N 2/01; B60N 2/90; B60R 11/00; B60R 11/02

(52) U.S. Cl. CPC B60R 16/04; B60N 2/01; B60N 2/90; B60R 2011/0015; B60R 2011/0082; B60R 11/0235

(57) ABSTRACT

A recreational vehicle includes a chassis, an occupant seating area supported by the chassis, the occupant seating area including a first row of seating having a seat back and a second row of seating behind the first row of seating, a battery, a housing coupled to the seat back, and a plurality of electronics powered by the battery, the plurality of electronics supported by the housing such that the plurality of electronics are accessible by an occupant in the second row of seating.

### BACKGROUND

Recreational vehicles (e.g., golf vehicles, personal transport vehicles, low speed vehicles, etc.) may be used to transport occupants between locations, such as landmarks along a tour. Occupants seated in a rear row of the vehicle may wish to control various vehicle functions and receive information about the vehicle's operation and the surrounding environment during transit, which may enhance the overall experience by allowing passengers more interaction and awareness during transit.

### SUMMARY

One embodiment relates to a recreational vehicle. The recreational vehicle includes a chassis and an occupant seating area supported by the chassis. The occupant seating area includes a first row of seating having a seat back and a second row of seating behind the first row of seating. The recreational vehicle includes a battery, a housing coupled to the seat back, and a plurality of electronics powered by the battery. The plurality of electronics are supported by the housing such that the plurality of electronics are accessible by an occupant in the second row of seating.

Another embodiment relates to a recreational vehicle. The recreational vehicle includes a chassis and an occupant seating area supported by the chassis. The occupant seating area includes a first row of seating supported by the chassis and a second row of seating behind the first row of seating. The first row of seating includes a seat bottom, a seat back, a support member extending from the seat bottom and configured to support the seat back, and a pedestal configured to support the seat bottom. The recreational vehicle includes a battery disposed within the pedestal, a housing coupled to the seat back, a plurality of electronics powered by the battery and supported by the housing, and wiring extending from the battery, through the pedestal, into the support member, and into a cavity between the seat back and the housing to power the plurality of electronics.

Still another embodiment relates to a recreational vehicle. The recreational vehicle includes a chassis and an occupant seating area supported by the chassis. The occupant seating area includes a first row of seating having a seat back and a second row seating behind the first row seating. The recreational vehicle includes a battery, a housing coupled to the seat back, and a plurality of electronics powered by the battery. The plurality of electronics are supported by the housing such that the plurality of electronics are accessible by an occupant in the second row of seating. The plurality of electronics include a display configured to provide a visual output to the occupant in the second row of seating, a speaker configured to provide an audio output to the occupant, a fan configured to direct airflow at the occupant, and a charging port or a wireless charging interface.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a perspective view of the vehicle of FIG. 1 including an infotainment system, according to an exemplary embodiment.

FIG. 6 is a perspective view of the infotainment system of FIG. 6, according to an exemplary embodiment.

FIG. 7 is a perspective view of the vehicle of FIG. 1 including the infotainment system of FIG. 6, according to an exemplary embodiment.

FIG. 8 is a perspective view of a vehicle of including three rows of seating and the infotainment system of FIG. 6, according to an exemplary embodiment.

FIG. 9 is a schematic block diagram of the infotainment system of FIG. 6, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

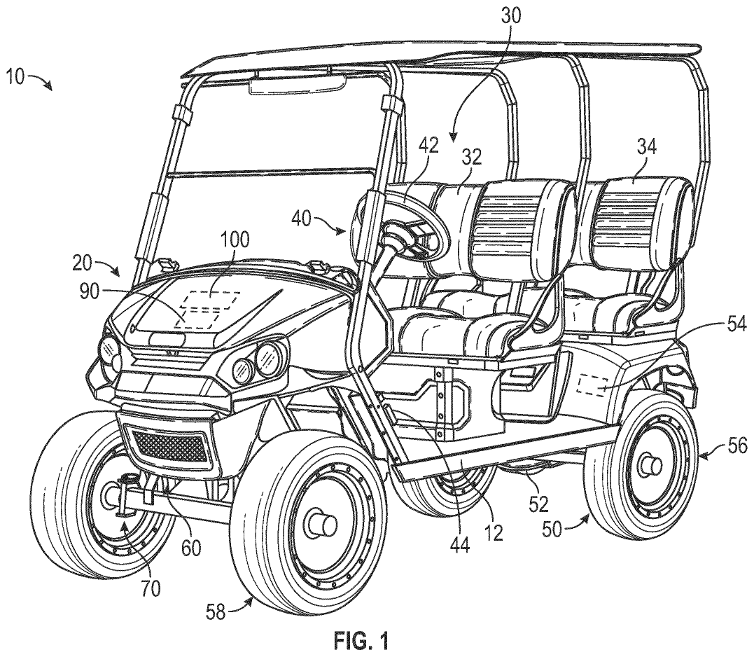

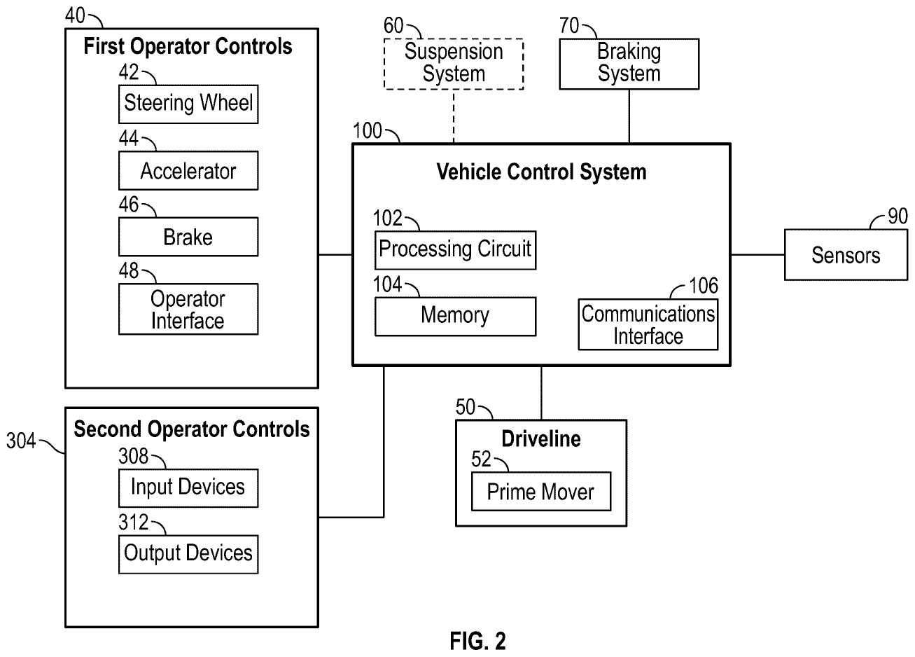

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as first operator control 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the first operator control 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the first operator control 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the first operator control 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the first operator control 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the first operator control 40, the components of the driveline 50, the components of the braking system 70, the sensors 90, and/or remote systems or devices (via the communications interface 106 as described in greater detail herein).

### Electrified Driveline

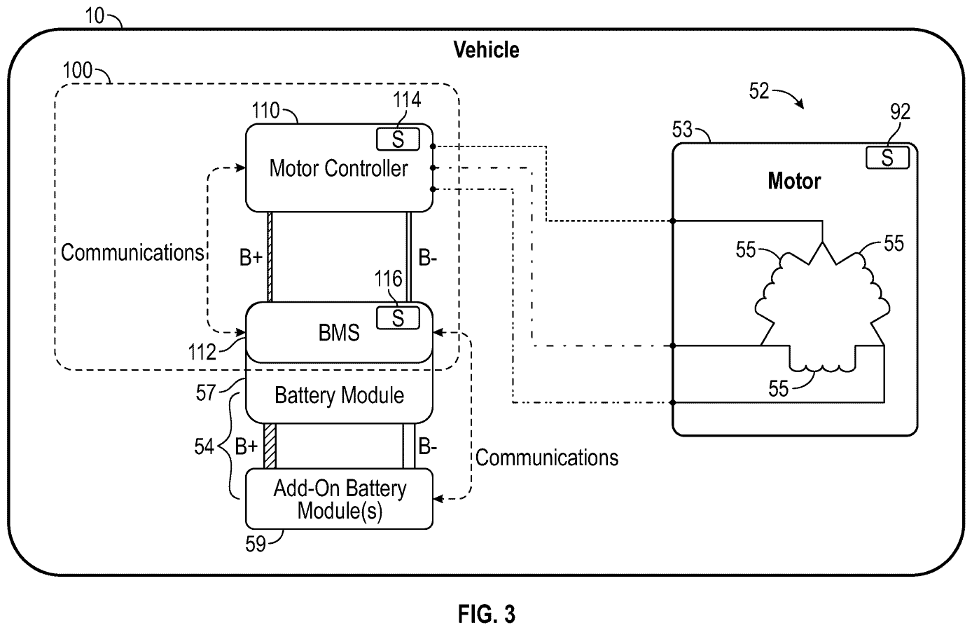

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

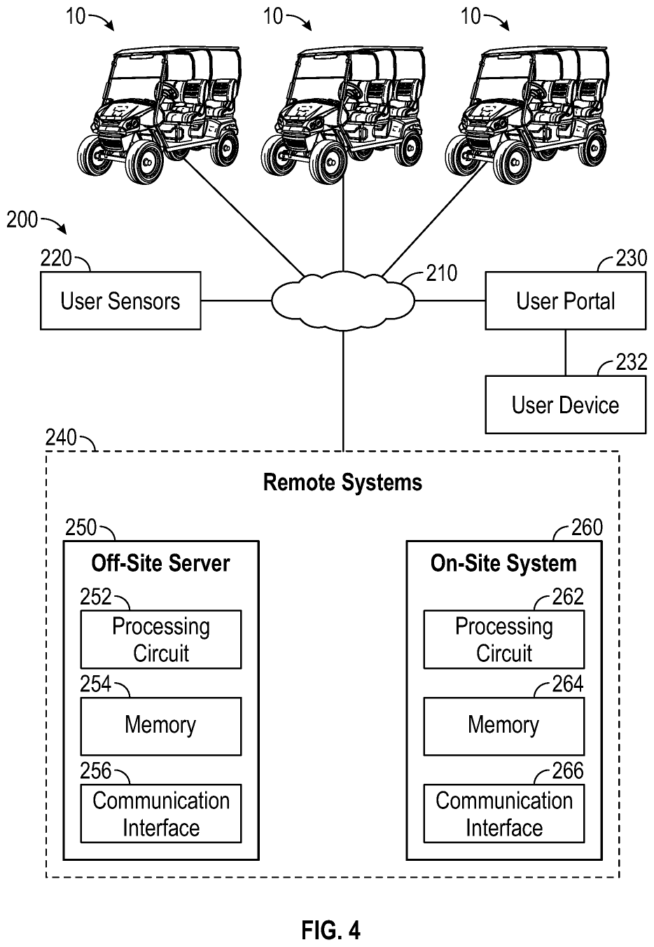

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Rear Seat Infotainment

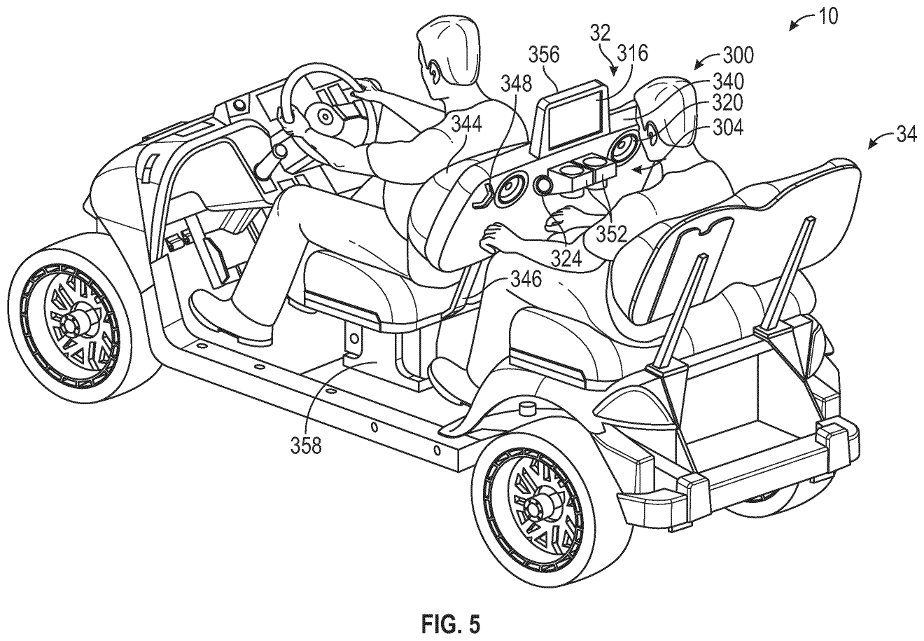

According to the exemplary embodiments shown in FIGS. 5-8, the occupant seating area 30 includes a rear seat information and entertainment system (e.g., rear row seating infotainment system), shown as rear seat infotainment system 300. The rear seat infotainment system 300 facilitates providing information and entertainment to one or more occupants (e.g., passengers, operators, etc.) in the occupant seating area 30. More specifically, the rear seat infotainment system 300 facilitates providing information and entertainment to the occupants in the rear row seating 34 (e.g., occupants behind the front row seating 32) and/or people outside of the vehicle 10. In embodiments with the occupant seating area 30 including a third row of seating or intermediate/middle row seating positioned between the front row seating 32 and the rear row seating 34, the rear seat infotainment system 300 facilitates providing information and entertainment to the occupants in the third row of seating.

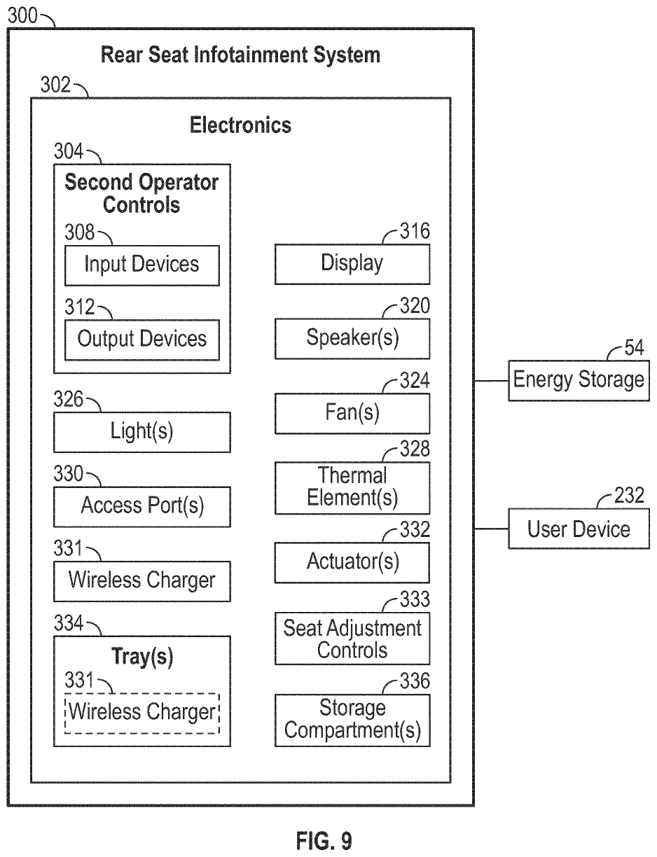

As shown in FIGS. 2, 5, 6, 8, and 9, the rear seat infotainment system 300 includes a plurality of electronics, shown as electronics 302, including operator input and output devices, shown as second operator controls 304, and a shell (e.g., casing, mold, support structure, etc.), shown as housing 340, configured to support the second operator controls 304 within the occupant seating area 30. Specifically, the housing 340 is configured to couple the second operator controls 304 to a rear of the front row seating 32 (and/or the rear row seating 34 in embodiments including the third row of seating).

According to an exemplary embodiment, the second operator controls 304 are configured to provide an operator (e.g., an occupant sitting on, standing in, disposed within, etc. the rear row seating 34) with the ability to control one or more functions of and/or provide commands to the vehicle 10 and the components thereof (e.g., turn on, turn off, engage various operating modes, control an audio system, etc.). As shown in FIG. 2, the second operator controls 304 include one or more input interfaces, shown as input devices 308, and one or more output interfaces, shown as output devices 312. The input devices 308 may be or include buttons, switches, knobs, levers, dials, etc. The output devices 312 may be or include a touchscreen, a LCD display, a LED display, gauges, warning lights, fans, heating/cooling elements, haptic actuators, etc. In some embodiments, the input devices 308 and/or the output devices 312 include one or more additional components.

As shown in FIG. 2, the second operator controls 304 are configured to communicate with the vehicle control system 100 to exchange information. By way of example, the input devices 308 may provide one or more inputs to the vehicle control system 100 to indicate interactions with the input devices 308. In other words, the input devices 308 may receive inputs (e.g., from an operator of the vehicle 10, from an occupant in the rear row seating 34, etc.) and provide the inputs to the vehicle control system 100. By way of another example, the vehicle control system 100 may send and receive signals with the output devices 312 to provide information and/or entertainment to the occupants. In some embodiments, the input devices 308 receive inputs from the occupant to control operation of the output devices 312. The information may be related to the operation of the vehicle 10 (e.g., a speed of the vehicle 10, a fuel level (e.g., a charge level of the energy storage 54), a location (e.g., on a map) of the vehicle 10, etc.), information associated with an area (e.g., a golf course, a historic site, etc.) surrounding the vehicle 10, one or more warnings or alerts, an input provided to the input devices 308, and/or other information. The entertainment may include audio (e.g., music, podcasts, audio books, radio, guided tour information, etc.), games and interactive applications, movies, television shows, advertisements, and/or other entertainment. In some embodiments, the information and/or entertainment is provided to the occupants visually (e.g., by a display), audibly (e.g., by an audio system including one or more speakers, horns, buzzers, etc.), and/or haptically (e.g., by a haptic actuator) by the output devices 312.

As shown in FIGS. 5, 6, and 8, the output devices 312 include a touchscreen, a LCD display, a LED display, etc., shown as display 316. The display 316 is configured to provide the information and the entertainment to the occupants visually (e.g., provide a visual output). In some embodiments, the display 316 is a touchscreen configured to receive an input from the occupant and provide a signal indicative of the input to the vehicle control system 100. In such embodiments, the display 316 may be an input device 308 configured to control operation of the output devices 312. By way of example, the occupant may provide an input to the display 316 to turn a fan (e.g., fan 324) “on” or “off”, control a speed of the fan, control a temperature of the airflow provided by the fan, control an audio output from an audio system (e.g., the speakers 320), control the information and/or entertainment displayed by the display 316, etc. In some embodiments, the display 316 is configured to display information (e.g., based on data acquired by the sensors 90, 220) regarding the location of the vehicle 10. By way of example, the display 316 may display a graphical representation of the location of the vehicle 10 on a map of the area surrounding the vehicle 10 to facilitate navigation of the vehicle 10. By way of another example, the display 316 may display information associated with an area surrounding the vehicle 10, such as information associated with a hole of a golf course that the vehicle 10 is on, information associated with landmarks (e.g., historical sites, buildings, statues, monuments, etc.) by the vehicle 10 as the vehicle 10 is driven along a tour route, for example, among other information. In some embodiments, the display 316 is configured to display a warning providing an indication to the occupants of the state of the vehicle 10 (e.g., the location of the vehicle 10) and/or an operation of the vehicle 10 (e.g., shifting or operating the vehicle 10 in reverse). In some embodiments, the rear seat infotainment system 300 includes more or fewer displays 316 than shown in FIGS. 5, 6, and 8.

As shown in FIGS. 5-8, the output devices 312 include an audio system, shown as speakers 320, configured to provide audible indications (e.g., information) to the occupants of the vehicle 10. The audible indications may include tones played at one or more volumes, patterns, verbal messages, reverse buzzers, etc. The speakers 320 may play audio associated with a movie, television show, advertisement, game, or guided tour information being displayed by the display 316. The speakers 320 may play warning providing an indication to the occupants of the state of the vehicle 10 (e.g., the location of the vehicle 10) and/or an operation of the vehicle 10 (e.g., shifting or operating the vehicle 10 in reverse).

As shown in FIGS. 5-8, the output devices 312 include one or more fans (e.g., blowers), shown as fans 324, configured to direct airflow from a heating, ventilation, and air conditioning (HVAC) system of the vehicle 10 towards the occupants of the vehicle 10. The fans 324 may direct airflow across a heater (e.g., a resistance heater) to heat the air and/or an evaporator to cool the air. In some embodiments, the occupant can provide an input to the input devices 308 to control a speed of the fans 324 and a temperature of the air directed by the fans 324. In some embodiments, the output devices 312 include a mister (e.g., a mist generator) configured to atomize a liquid (e.g., water) and direct the atomized liquid (e.g., mist) in a direction towards the occupant. In some embodiments, the fan 324 is configured to direct airflow over the mister to direct the atomized liquid in a direction towards the occupant.

In some embodiments, the output devices 312 include one or more lights, shown as lights 326, configured to emit light in various patterns, with various colors, at various frequencies, and/or with varying intensities or brightness. The lights 326 may be coupled to the vehicle 10 within the occupant seating area 30, with the housing 340 of the rear seat infotainment system 300, along a floor of the vehicle 10, and/or other various locations. In some embodiments, the lights 326 emit light indicative of the state of the vehicle 10 and/or an operation of the vehicle 10 (e.g., shifting or operating the vehicle 10 in reverse). In some embodiments, the lights 326 emit light to illuminate an environment surrounding the vehicle 10. By way of example, the lights 326 may illuminate the edges of the floor such that vehicle 10 is visible in an otherwise dark environment.

In some embodiments, the output devices 312 include temperature control elements, shown as thermal elements 328, coupled with cupholders (e.g., cupholders 352). The thermal elements 328 may include heating elements (e.g., resistance heaters, Peltier devices, etc.) configured to transfer thermal energy to an item (e.g., cup bottle, vessel, etc.) stored by or received in the cupholders to heat the item and the contents within the item. The thermal elements 328 may include cooling elements (e.g., a refrigeration circuit, Peltier devices, solid-state refrigeration or thermoelectric cooling devices, etc.) configured to remove thermal energy from the item stored by the cupholders to cool the item and the contents within the item. In some embodiments, an amount of thermal energy added to or removed from the items received by the cupholders by the thermal elements 328 (e.g., a temperature of the items) is controlled based on an input from the occupant to the input devices 308. In other embodiments, a sensor 90 (e.g., a proximity sensor) is coupled to the cupholders and configured to monitor whether an item is being stored by the cupholders. In such embodiments, the thermal elements 328 are powered (e.g., to add or remove thermal energy) responsive to a determination (e.g., by the vehicle control system 100), based on the data acquired by the sensor 90, that the item is stored in the cupholders (e.g., to automatically heat or cool the contents within the item when an occupant places the item in the cupholders). In some embodiments, the thermal elements 328 are coupled with a storage area (e.g., a box, a bin, a container, etc.) coupled to the vehicle 10 and configured to add thermal energy to or remove thermal energy from the storage area to heat or cool the interior volume defined by the storage area. By way of example, the storage area may include a cooler configured to store one or more items (e.g., drinks, food, ice, etc.) and the thermal elements 328 may be configured to remove thermal energy from the cooler to facilitate cooling the one or more items. In some embodiments, a temperature of the storage area (e.g., an amount of thermal energy added to or removed from the storage area by the thermal elements 328) is controlled based on an input from the occupant to the input devices 308. The storage area may be accessed through a door positioned along the housing 340.

In some embodiments, the input devices 308 and/or the output devices 312 of the rear seat infotainment system 300 includes one or more external connection points, shown as access ports 330, configured to facilitate electrically coupling an external device with the vehicle 10. In other words, the access ports 330 may facilitate a wired connection between an external device and the vehicle 10. By way of example, the access ports 330 may include a universal serial bus (USB) port (e.g., USB-A, USB-B, USB-C, etc.), a 12 volt outlet, a 110 volt outlet, or some other charging port, configured to facilitate transferring electrical energy between the vehicle 10 and the external device (e.g., to charge a battery of the external device, to power the external device, etc.). In some examples, the rear seat infotainment system 300 includes a wireless charging interface, shown as wireless charger 331, configured to wirelessly charge the external device. By way of another example, the access ports 330 may include an audio port such as a 3.5 mm jack, a high-definition multimedia interface (HDMI) port, an optical port, etc., configured to facilitate transferring signals associated with audio between the vehicle 10 and the external device (e.g., between the speakers 320 and the external device). By way of still another example, the access ports 330 may include a video port such as an HDMI port, a video graphics array (VGA) port, etc., configured to facilitate transferring signals associated with video between the vehicle 10 and the external device (e.g., between the display 316 and the external device). In some embodiments, the external device is configured to communicate with the output devices 312 (e.g., to display video or provide sound) via one or more wireless communications protocols (e.g., Bluetooth, Wi-Fi, cellular, radio, through the Internet, etc.). The external device may include the user device 232, a computer, laptop, smartphone, tablet, or the like. By way of example, the occupant may control operation of one or more of the input devices 308 and/or output devices 312 (e.g., the display 316, the speakers 320, the fans 324, the thermal elements 328, the actuators 332, etc.) responsive to an input to the user device 232.

In some embodiments, the input devices 308 are configured to receive an input to actuate one or more electric actuators, hydraulic actuators, pneumatic actuators, etc., shown as actuators 332, to move one or more components of the vehicle 10 and the rear seat infotainment system 300. By way of example, the input devices 308 may include one or more buttons (e.g., levers, knobs, dials, etc.), shown as seat adjustment controls 333, configured to facilitate actuating the actuator 332 to adjust a position of the rear row seating 34 based on an input from the occupant to the seat adjustment controls 333. The seat adjustment controls 333 may facilitate adjusting a longitudinal position of the rear row seating 34, a vertical height of the rear row seating 34, a position of a back rest of the rear row seating 34 (e.g., a position of the back rest relative to a base of the rear row seating 34), a lumbar support of the rear row seating 34, etc. By way of another example, responsive to an input from the occupant, the actuators 332 may move a deployable tray, shown as tray 334, pivotably coupled with the housing 340 between a stowed position and a deployed position. In such examples, the tray 334 may include the wireless charger 331 disposed therealong and configured to wirelessly charge an external device. By way of still another example, responsive to an input from the occupant, the actuators 332 may move the display 316 between a retracted position and a deployed position (as discussed in greater detail below).

In some embodiments, the vehicle 10 includes a compartment (e.g., box, a bin, a container, etc.), shown as storage compartment 336, including a door movable between an open position and a closed position and a lock configured to selectively lock the door in the closed position to inhibit access to the storage compartment 336. The storage compartment 336 may include a cavity positioned between the housing 340 and the seat back (e.g., front row back rest 344). The lock may include a mechanical device (e.g., bolt, hook, etc.) actuatable between locked position and an unlocked position, an electromagnetic lock configured to selectively generate a magnetic force, a combination lock, or another type of lock. Responsive to an input to the input devices 308 associated with a command to unlock the lock (e.g., a password input to the display 316, a pin input to a number pad, a combination input to the combination lock, etc.), the lock may permit access to the storage compartment 336. In some embodiments, the storage compartment 336 includes the thermal elements 328. By way of example, the thermal elements 328 may include cooling elements configured to cool an interior volume of the storage compartment 336 (e.g., such that the storage compartment 336 is configured as a cooler, a refrigerator, a freezer, etc.). By way of another example, the thermal elements 328 may include heating elements configured to heat the interior volume of the storage compartment 336 (e.g., such that the storage compartment 336 is configured as a heater, an oven, a toaster, an air fryer, etc.). In some embodiments, the storage compartment 336 includes or is configured as vending machine (e.g., a food and beverage dispenser) configured to dispense food and/or beverages therefrom. The vending machine may dispense the food and/or beverages responsive to an input to a keypad, for example, by the occupant to the input devices 308. By way of example, the occupant may provide an input to the display 316, and responsive to receiving the input, the vending machine may dispense the food and/or beverage associated with (e.g., specified by) the input. The vending machine may include a payment interface configured to facilitate receiving payment (e.g., cash, credit/debit card, tap payment via an external device, etc.) from the occupant before dispensing the food and/or beverage.

In some embodiments, the rear seat infotainment system 300 includes one or more of the sensors 90. By way of example, the sensors 90 may include a position sensor, proximity sensor, limit switch, etc. configured to monitor whether a seatbelt of the rear row seating 34 is in an engaged position indicative of the occupant wearing the seatbelt. By way of another example, the sensors 90 may include a camera configured to monitor the rear row seating 34 and the operator and the vehicle control system 100 may determine, based on the data acquired by the sensors 90, whether the occupant is wearing the seatbelt.

As shown in FIGS. 5-8, the housing 340 is configured to facilitate coupling the second operator controls 304 with the front row seating 32. The housing 340 is coupled to a back side of a back rest, shown as front row back rest 344, of the front row seating 32 such that the second operator controls 304 are accessible by an occupant in the rear row seating 34, for example. The housing 340 may be coupled to the front row back rest 344 using one or more fasteners (e.g., bolts, nails, screws, rivets, anchors, etc.), adhesives, welds, snap-in connections, etc. The housing 340 may be formed as a single, unitary body (e.g., manufactured as one piece) or may include two or more sections coupled together. As shown in FIGS. 5-8, the front row back rest 344 and the housing 340 coupled therewith are supported by back rest and housing supports (e.g., frame members, support members, posts, etc.), shown as supports 336. The supports 336 vertically space the front row back rest 344 and the housing 340 from a seat bottom of the front row seating 32. In some embodiments, the supports 336 are hollow members configured to receive electrical wiring (e.g., wiring 360) and guide the wiring between the second operator controls 304 and a power source (e.g., the energy storage 54). In some embodiments, the front row back rest 344 and the housing 340 are supported by more or fewer than two supports 336. In some embodiments, the supports 336 are integrated with (e.g., formed with) the housing 340 as a single, unitary body.

As shown in FIGS. 5-8, the rear seat infotainment system 300 includes one or more supports, shown as grips 348, configured to provide a support for an occupant to grab (e.g., to help the occupant enter and exit the vehicle 10, to stabilize the occupant as the vehicle 10 travels, etc.). The rear seat infotainment system 300 includes a first grip 348 coupled to the housing 340 and positioned proximate a first lateral side (e.g., a left side) of the vehicle 10 and a second grip 348 coupled to the housing 340 and positioned proximate a second lateral side (e.g., a right side) of the vehicle 10. In some embodiments, the rear seat infotainment system 300 includes more or fewer grips 348 (e.g., a third grip 348 centered along the housing 340). In some embodiments, the grips 348 are integrally formed with the housing 340.

As shown in FIGS. 5-8, the rear seat infotainment system 300 includes cup supports, shown as cupholders 352, configured to support cups (e.g., cans, bottles, vessels, etc.). As shown, the rear seat infotainment system 300 includes two cupholders 352 centered along a lateral length of the housing 340. In some embodiments, the rear seat infotainment system 300 includes more or fewer than two cupholders 352. In some embodiments, the cupholders 352 are otherwise positioned. In some embodiments, the cupholders 352 are configured to couple with the housing 340 (e.g., using fasteners, adhesives, snap-in connections, etc.). In other embodiments, the cupholders 352 are integrally formed with the housing 340. The thermal elements 328 may be coupled to the cupholders 352 to facilitate adding thermal energy to or removing thermal energy from the cupholders 352 and/or the cups supported thereby (e.g., to heat or cool the cupholders 352 and/or the cups).

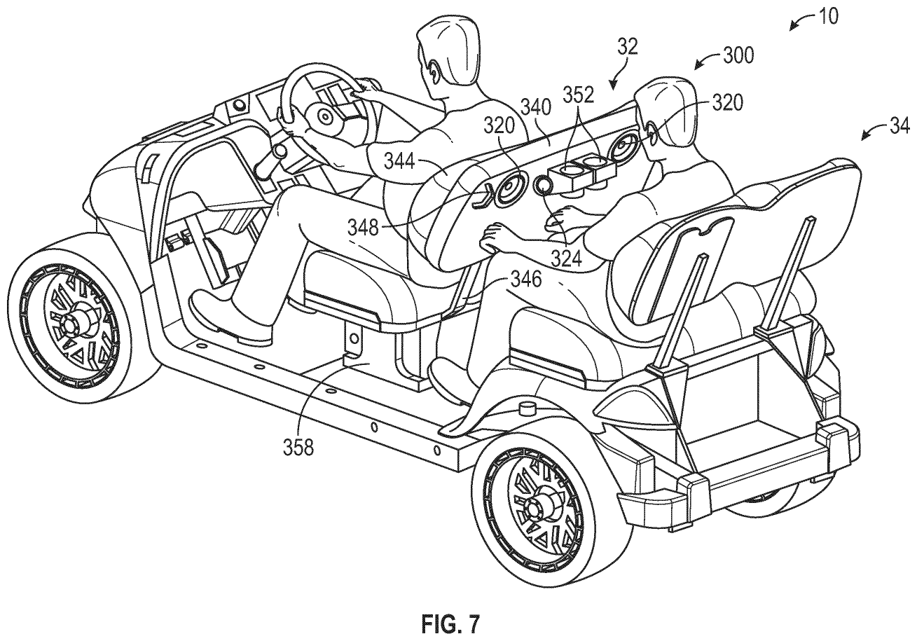

As shown in FIGS. 5, 6, and 8, the housing 340 includes a mount, shown as display mount 356, positioned along a top edge of the housing 340 and extending in a vertical direction away from the housing 340. The display mount 356 is configured to couple the display 316 with the housing 340 and the front row seating 32. The display mount 356 defines an opening such that, when the display 316 is supported by the display mount 356, the display 316 is visible from the rear row seating 34 (e.g., visible by an occupant sitting on the rear row seating 34). In some embodiments, the display mount 356 and the display 316 supported thereby are actuatable (e.g., by the actuators 332) between a deployed position (shown in FIGS. 5, 6, and 8) and a retracted position (e.g., shown in FIG. 7). In the retracted position, the display mount 356 and the display 316 may be positioned within a cavity between the housing 340 and the front row back rest 344 (e.g., such that the display 316 is not visible from the rear row seating 34). The display mount 356 and the display 316 may be transitioned between the deployed position and the retracted position responsive to an input from the occupant to the input devices 308. In some embodiments, the display 316 is selectively removable from the display mount 356 and can be held by the occupant (e.g., for use as a tablet). In some embodiments, the housing 340 does not include the display mount 356. In such embodiments, the display 316 is otherwise coupled to the front row back rest 344 by the housing 340.

As shown in FIGS. 5-8, the housing 340 includes a plurality of apertures configured to receive at least a portion of the second operator controls 304. The apertures may be sized and shaped to accommodate the various sizes and shapes of the various second operator controls 304. By way of example, a first set of apertures may be sized and shaped complementary to a size and shape of the speakers 320 such that the speakers 320 are supported by the housing 340. By way of another example, a second set of apertures may be sized and shaped complementary to a size and shape of the fans 324 (and/or vents configured to direct airflow from the fans 324) such that the fans 324 (and/or the vents) are supported by the housing 340.

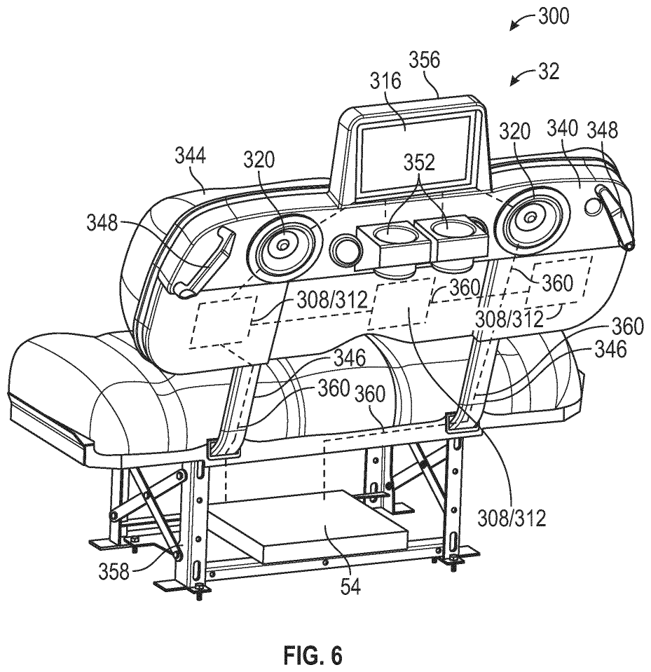

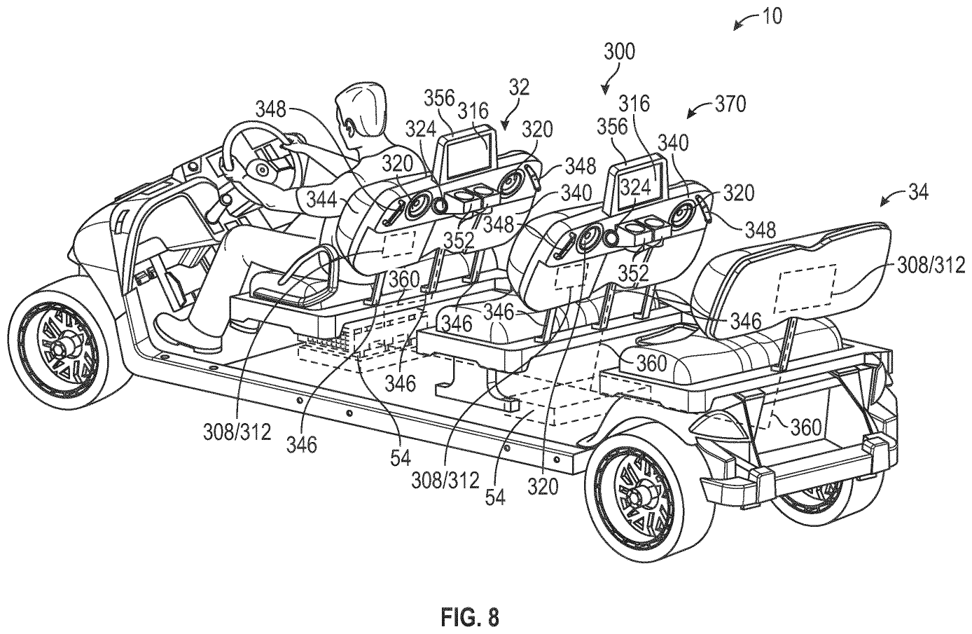

As shown in FIGS. 6 and 8, the energy storage 54 is positioned along a floor of the vehicle 10 below the front row seating 32 within a base, shown as pedestal 358, thereof). According to an exemplary embodiment, the pedestal 358 is configured to couple to a floor of the vehicle 10 and to space the front row back rest 334, the housing 340 coupled therewith, and the seat bottom of the front row seating 32 from the floor. In some embodiments, the energy storage 54 is otherwise positioned (e.g., below the rear row seating 54). As shown in FIGS. 6 and 8, the rear seat infotainment system 300 includes electrical wiring (e.g., cables), shown as wiring 360, configured to electrically couple the energy storage 54 with the second operator controls 304. The energy storage 54 may provide electrical energy to the second operator controls 304 via the wiring 360 to power the second operator controls 304. As shown in FIGS. 6 and 8, the wiring 360 extends vertically upwards from the energy storage 54 into internal passages of the supports 336 (e.g., the supports 336 receive at least a portion of the wiring 360). The supports 336 guide the wiring 360 to the second operator controls 304 supported by the housing 340. Guiding the wiring 360 through the supports 336 helps to protect the wiring 360 from an external environment (e.g., an environment external to the supports 336). As shown in FIG. 6, the wiring 360 extends between the second operator controls 304 (e.g., within a cavity disposed between the housing 340 and the front row back rest 344).

According to an exemplary embodiment shown in FIG. 8, the vehicle 10 includes a third row of seating, shown as intermediate row seating 370, positioned between the front row seating 32 and the rear row seating 34 (e.g., such that the rear row seating 34 is the rearmost row of seating). In such an embodiment, the rear seat infotainment system 300 includes a housing 340 configured to facilitate coupling the second operator controls 304 with the intermediate row seating 370 (e.g., such that the second operator controls 304 are accessible by an occupant in the rear row seating 34). By way of example, a first housing 340 couples a first set of second operator controls 304 to the front row seating 32 (e.g., such that the second operator controls 304 are accessible by an occupant in the intermediate row seating 370) and a second housing 340 couples a second set of second operator controls 304 to the intermediate row seating 370. As shown FIG. 8, the vehicle 10 includes a first energy storage 54 below the front row seating 32 and a second energy storage 54 below the intermediate row seating 370. The wiring 360 extends upwards (e.g., through the supports 336 supporting a back rest of the intermediate row seating 370 and the housing 340) and electrically couples the second energy storage 54 with the second operator controls 304 supported by the housing 340 coupled with the intermediate row seating 370 to provide electrical energy to power the second operator controls 304. In some embodiments, the vehicle 10 does not include the second energy storage 54 such that the wiring 360 extends from the first energy storage 54 to the second operator controls 304 supported by the housing 340 coupled with the intermediate row seating 370. In such embodiments, the wiring 360 may extend, at least partially, below the floor of the vehicle 10.

As shown in FIG. 8, the second operator controls 304 are coupled to a rear side of a rear row back rest of the rear row seating 34. The wiring 360 extends, at least partially, from the first energy storage 54 or the second energy storage 54 to the second operator controls 304. In some embodiments, the second operator controls 304 include a rear-facing display (e.g., display 316) configured to display information and/or entertainment in a direction towards a rear end of the vehicle 10. By way of example, the display may display an advertisement or other messages at other vehicles or pedestrians behind the vehicle 10. In some embodiments, the second operator controls 304 include a sensor 90 such as a camera (e.g., a backup camera). In such embodiments, the camera may acquire image data and provide a signal indicative of the data to the display 316 such that the display 316 displays the image data acquired by the camera.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the first operator control 40, the driveline 50, the suspension system 60, the braking system 70, the sensors 90, the vehicle control system 100, etc.), the fleet monitoring and control system 200 (e.g., the remote systems 240, the user portal 230, the user sensors 220, etc.), and the rear seat infotainment system 300 as shown in the various exemplary embodiments is illustrative only. Additionally, any element disclosed in one embodiment may be incorporated or utilized with any other embodiment disclosed herein.

1. A recreational vehicle comprising:
a chassis;
an occupant seating area supported by the chassis, the occupant seating area including:
a first row of seating having a seat back; and
a second row of seating behind the first row of seating;
a battery;
a housing coupled to the seat back; and
a plurality of electronics powered by the battery, the plurality of electronics supported by the housing such that the plurality of electronics are accessible by an occupant in the second row of seating.

2. The recreational vehicle of claim 1, wherein the plurality of electronics include a display configured to provide a visual output to the occupant in the second row of seating.

3. The recreational vehicle of claim 2, wherein the housing includes a mount positioned along a top edge of the housing, the mount configured to support the display.

4. The recreational vehicle of claim 3, wherein the mount is movable between a retracted position and a deployed position, wherein, in the retracted position, the display is disposed within a cavity between the housing and the seat back, and, in the deployed position, the display is visible by the occupant in the second row of seating.

5. The recreational vehicle of claim 3, wherein the display is selectively removable from the mount.

6. The recreational vehicle of claim 1, wherein the first row of seating includes a support member configured to support the seat back and the housing.

7. The recreational vehicle of claim 6, further comprising wiring electrically coupling the plurality of electronics to the battery, and wherein the support member is configured to receive a portion of the wiring to guide the wiring between the plurality of electronics and the battery.

8. The recreational vehicle of claim 7, wherein the first row of seating includes a pedestal, wherein the battery is positioned within the pedestal, and wherein the wiring extending from the battery, through the pedestal, into the support member, and into a cavity between the seat back and the housing.

9. The recreational vehicle of claim 7, wherein the support member is integrally formed with the housing.

10. The recreational vehicle of claim 1, wherein the plurality of electronics include a speaker configured to provide an audio output to the occupant.

11. The recreational vehicle of claim 1, wherein the plurality of electronics include a fan configured to direct airflow at the occupant.

12. The recreational vehicle of claim 1, further comprising a cupholder coupled to the housing, wherein the plurality of electronics include a thermal element configured to heat or cool an item received within the cupholder.

13. The recreational vehicle of claim 1, wherein the plurality of electronics includes a charging port or a wireless charging interface.

14. The recreational vehicle of claim 1, wherein the housing includes a door providing access to a compartment between the seat back and the housing, and wherein the plurality of electronics include a thermal element configured to heat or cool the compartment.

15. The recreational vehicle of claim 1, further comprising a deployable tray coupled to the housing, and wherein the plurality of electronics include a wireless charger disposed along the deployable tray.

16. The recreational vehicle of claim 1, further comprising a third row of seating positioned behind the second row of seating, the third row of seating being a rearmost row of seating, the third row of seating supporting at least one of a camera or rear-facing display.

17. The recreational vehicle of claim 1, further comprising a sensor configured to monitor a location of the recreational vehicle, wherein the plurality of electronics include a display configured to provide a visual output to the occupant in the second row of seating, and wherein the visual output is indicative of the location of the recreational vehicle.

18. The recreational vehicle of claim 1, wherein the recreational vehicle is configured as a golf cart, an all-terrain vehicle, a utility task vehicle, a low speed vehicle, or a personal transport vehicle.

19. A recreational vehicle comprising:
a chassis;
an occupant seating area supported by the chassis, the occupant seating area including:
a first row of seating supported by the chassis, the first row of seating including:
a seat bottom;
a seat back;
a support member extending from the seat bottom and configured to support the seat back; and
a pedestal configured to support the seat bottom; and
a second row of seating behind the first row of seating;
a battery disposed within the pedestal;
a housing coupled to the seat back;
a plurality of electronics powered by the battery, the plurality of electronics supported by the housing; and
wiring extending from the battery, through the pedestal, into the support member, and into a cavity between the seat back and the housing to power the plurality of electronics.

20. A recreational vehicle comprising:
a chassis;
an occupant seating area supported by the chassis, the occupant seating area including:
a first row of seating having a seat back; and
a second row seating behind the first row seating;
a battery;
a housing coupled to the seat back; and
a plurality of electronics powered by the battery, the plurality of electronics supported by the housing such that the plurality of electronics are accessible by an occupant in the second row of seating, the plurality of electronics including:
a display configured to provide a visual output to the occupant in the second row of seating;
a speaker configured to provide an audio output to the occupant;
a fan configured to direct airflow at the occupant; and
a charging port or a wireless charging interface.
